(19) United States
(12) Patent Application Publication
(10) Pub. No.: US 2017/0193845 A1
(43) Pub. Date: Jul. 6, 2017

(54) DETECTION OF ANOMALOUS BEHAVIOR IN DIGITAL EDUCATION SETTINGS BASED ON PORTABLE DEVICE MOVEMENT

(71) Applicant: International Business Machines Corporation, Amonk, NY (US)

(72) Inventors: Carlos Henrique Cardonha, Sao Paulo (BR); Rodrigo Laiola Guimaraes, Sao Paulo (BR); Andrea Britto Mattos Lima, Sao Paulo (BR)

(21) Appl. No.: 14/984,000

(22) Filed: Dec. 30, 2015

(51) Int. Cl. G09B 19/00; G09B 5/02

(52) U.S. Cl. CPC G09B 19/00; G09B 5/02

(57) ABSTRACT

A computer-implemented method for determining anomalous behavior in a digital education setting is provided. The method including the steps of: receiving, by a processor of a computer system, data corresponding to a position of a device with respect to at least one axis of the device; determining, by the processor of the computer system, whether the position of the device is an appropriate location for an intended use of the device; and notifying, by the processor of the computer system, wherein the device is not in an appropriate location for an intended use of the device.

### BACKGROUND

The present invention relates to digital education settings, and more specifically, to a computer-implemented method and system for determining or detecting anomalous behavior in a digital education setting.

Computer-aided testing is becoming more prevalent as users of data networks realize the potential to administer and score the test via electronic means. Many facilities administering standardized tests are now using electronic devices as a replacement to traditional paper answer sheets.

Cheating on exams is a problematic habit that prevents educators from properly determining how well their students are able to acquire and apply information taught in the class. Cheating detection and prevention is a hard task considering that there are several forms of cheating: examinees can do it individually (e.g., using cheat sheets) or in group (by copying one from another). In this scenario, anti-cheating mechanisms applied in schools are fundamental to assist the proctors during the exams.

Therefore, it is desirable to have an apparatus, system and method by which a testing environment can be monitored.

### SUMMARY

According to an embodiment, a computer-implemented method for determining anomalous behavior in a digital education setting is provided. The method including the steps of: receiving, by a processor of a computer system, data corresponding to a position of a device with respect to at least one axis of the device; determining, by the processor of the computer system, whether the position of the device is an appropriate location for an intended use of the device; and notifying, by the processor of the computer system, wherein the device is not in an appropriate location for an intended use of the device.

According to another embodiment, a system for determining anomalous behavior in a digital education setting, the system having: a memory; a processor communicatively coupled to the memory, wherein the processor is configured to perform: receiving, by a processor of a computer system, data corresponding to a position of a device with respect to at least one axis of the device; determining, by the processor of the computer system, whether the position of the device is an appropriate location for an intended use of the device; and notifying, by the processor of the computer system, wherein the device is not in an appropriate location for an intended use of the device.

According to yet another embodiment, a computer program product for determining anomalous behavior in a digital education setting is provided. The computer program product having: a non-transitory storage medium readable by a processing circuit and storing instructions for execution by the processing circuit for performing a method comprising: receiving, by a processor of a computer system, data corresponding to a position of a device with respect to at least one axis of the device; determining, by the processor of the computer system, whether the position of the device is an appropriate location for an intended use of the device; and notifying, by the processor of the computer system, wherein the device is not in an appropriate location for an intended use of the device.

### BRIEF DESCRIPTION OF THE DRAWINGS

The accompanying figures wherein reference numerals refer to identical or functionally similar elements throughout the separate views, and which together with the detailed description below are incorporated in and form part of the specification, serve to further illustrate various embodiments and to explain various principles and advantages all in accordance with the present invention, in which:

FIG. 1 illustrates a system for detection of anomalous behavior in a digital education setting;

FIGS. 2A and 2B are block diagrams of a portable device for use in the system of FIG. 1;

FIGS. 3A and 3B illustrate orientations of two portable devices being used by a pair of students;

FIGS. 4A and 4B illustrate orientations of two portable devices being used by a pair of students wherein one of the portable devices is in an unauthorized position during a test;

FIGS. 5A and 5B illustrate orientations of two portable devices being used by a pair of students wherein one of the portable devices is being moved in an unauthorized direction during a test;

FIG. 6 is a flow chart illustrating the computer-implemented method of detecting a anomalous behavior in a digital education setting; and

FIG. 7 is a block diagram illustrating an exemplary embodiment of an information processing system for use with the methods disclosed herein.

### DETAILED DESCRIPTION

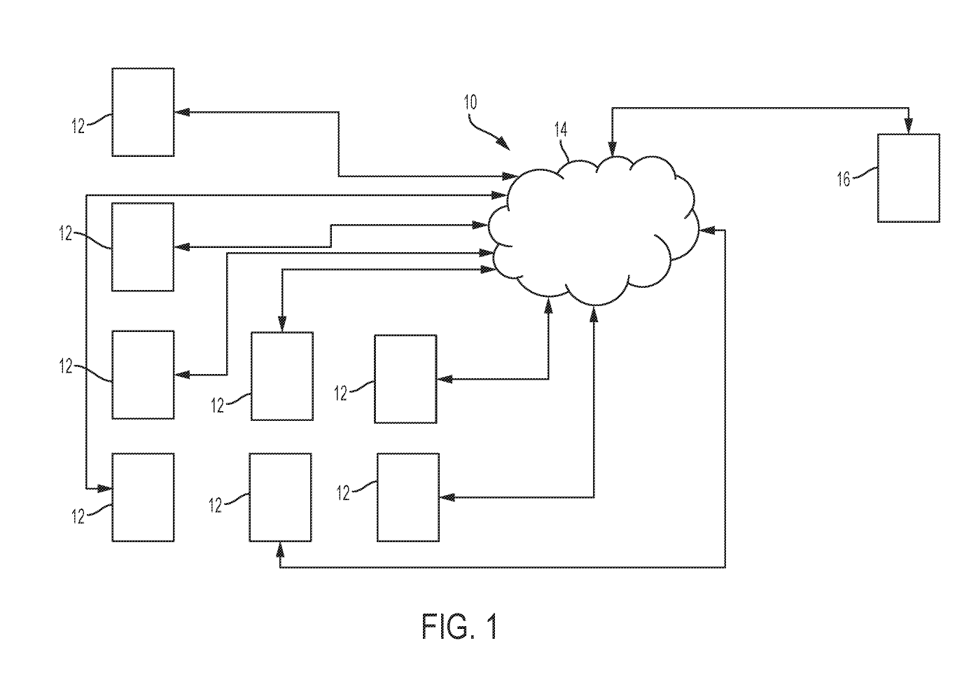

With reference now to FIG. 1, a system 10 for detection of anomalous behavior in a digital education setting. In accordance with various embodiments of the present disclosure, the system 10 is configured to identify potential anomalous behavior in exams being taken on portable devices or portable digital devices or digital devices 12 that are able to collect information about their position and/or orientation as well as provide a means for administering the test and collecting the submitted answers. The system will further comprise a server 14 in operative communication with each one of the portable devices 12. The communication between the devices 12 and the server 14 may be in the form of a wireless or wired communication illustrated by the arrows in FIG. 1 wherein data can be exchanged between the server 14 and the devices 12. Also shown is a proctor device 16, which may also be a portable device or standalone computer in operative communication with the server 14.

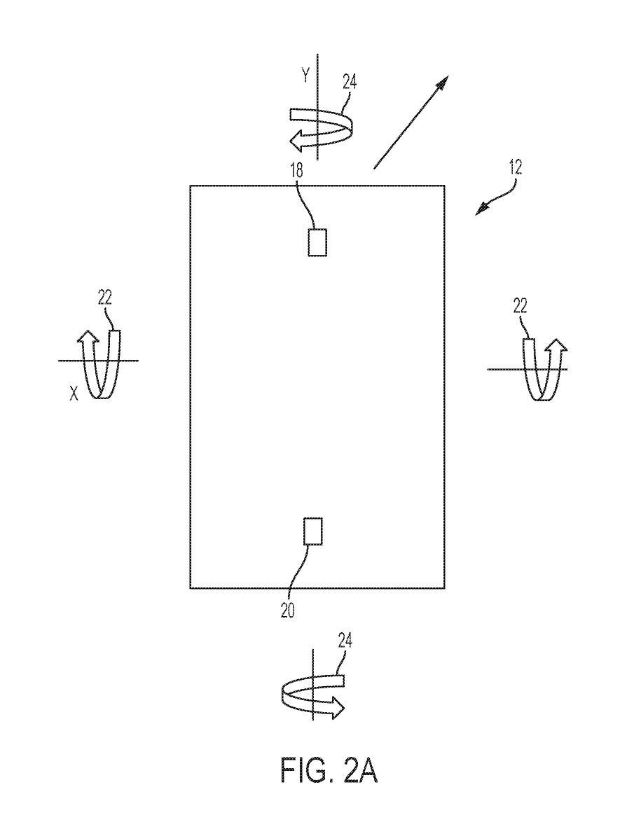

Referring now to FIG. 2A one of the plurality of portable devices 12 is illustrated. As mentioned above portable device 12 may be a tablet and/or a smartphone equipped with a sensor or gyroscope 18 and an accelerometer sensor or sensors 20. The gyroscope 18 and an accelerometer sensor or sensors 20 are configured to detect movement of the portable device 12 about at least 3 axes. For example, a pitch of the device 12 about an X axis in the direction of arrows 22 may be detected. Also, a roll of the device 12 about a Y axis in the direction of arrows 24 may be detected. Still further, the orientation of the device with respect to a vertical Y axis may be detected (see for example arrow 24 with respect to the Y axis). The device 12 will also have a Z axis that extends upwardly from the Figure. Although only one sensor 18 and one sensor 20 are shown it is, of course, contemplated that more than one sensor 18 and sensor 20 can be located on the device 12 in order to determine its location about its X, Y and Z axes. Still further, sensors 18 and 20 may be any type of sensor configured to detect any type of movement of the device 12 (e.g., about an axis of the device 12, acceleration of the device 12, vibration of the device 12, etc.).

As is known the related arts device and referring now to FIG. 2B, the device 12 may be a suitably configured processing system configured to implement one or more functions described herein, including the transmission of device orientation data from sensors 18 and 20 to the sever 14 in addition to an operational system configured to perform a desired function(s) such as the administration of a test displayed on device 12. Any suitably configured processing system can be used as the device 12. The components of the device 12 can include, but are not limited to, one or more processors or processing units 110, a system memory 120 and a bus 130 that couples various system components including the system memory 120 to the processor 110.

The bus 130 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture bus, Micro Channel Architecture bus, Enhanced ISA bus, Video Electronics Standards Association local bus and Peripheral Component Interconnects bus.

Although not shown in FIG. 2B, the system memory 120 may include the calculating, information confidence rating and annotating information software module(s). The system memory 120 can also include computer system readable media in the form of volatile memory, such as random access memory (“RAM”) 135 and/or cache memory 140. The device 12 can further include other removable/non-removable, volatile/non-volatile computer system storage media. By way of example only, a storage system 150 can be provided for reading from and writing to a non-removable or removable, non-volatile media such as one or more solid state disks and/or magnetic media (typically called a “hard drive”). A magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus 130 by one or more data media interfaces. The memory 120 can include at least one program product having a set of program modules that are configured to carry out the functions of the embodiments described herein.

Program/utility 160, having a set of program modules 170, may be stored in memory 120 by way of example, and not limitation, as well as an operating system, one or more application programs, other program modules, and program data. Each of the operating system, one or more application programs, other program modules, and program data or some combination thereof, may include an implementation of a networking environment. Program modules 170 generally carry out the functions and/or methodologies of the embodiments described herein.

The device 12 can also communicate with one or more external or associated devices 180 such as a keyboard, a pointing device, a display 190, etc.; one or more devices that enable a user to interact with the device 12; and/or any devices, e.g., network card, modem, etc., that device 12 to communicate with the server 14. Such communication can occur via I/O interfaces 200. Still yet, the device 12 can communicate with one or more networks such as a local area network, a general wide area network, and/or a public network, e.g., the Internet, via network adapter 210. As depicted, the network adapter 210 communicates with the other components of device 12 via the bus 130. Other hardware and/or software components can also be used in conjunction with the device 12. Examples include, but are not limited to: microcode, device drivers, redundant processing units, external disk drive arrays, RAID systems, tape drives and data archival storage systems.

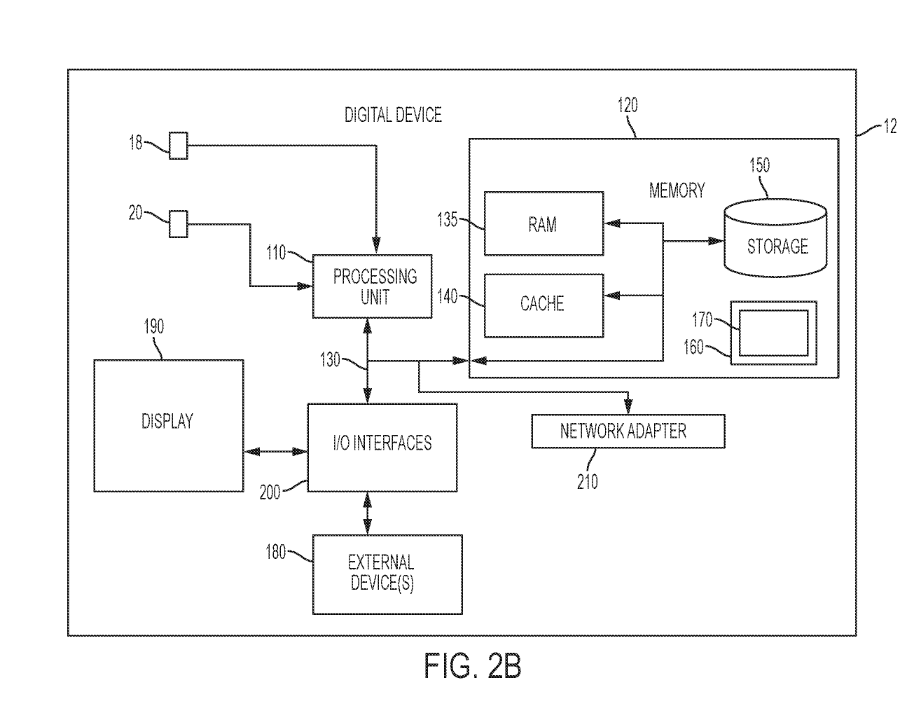

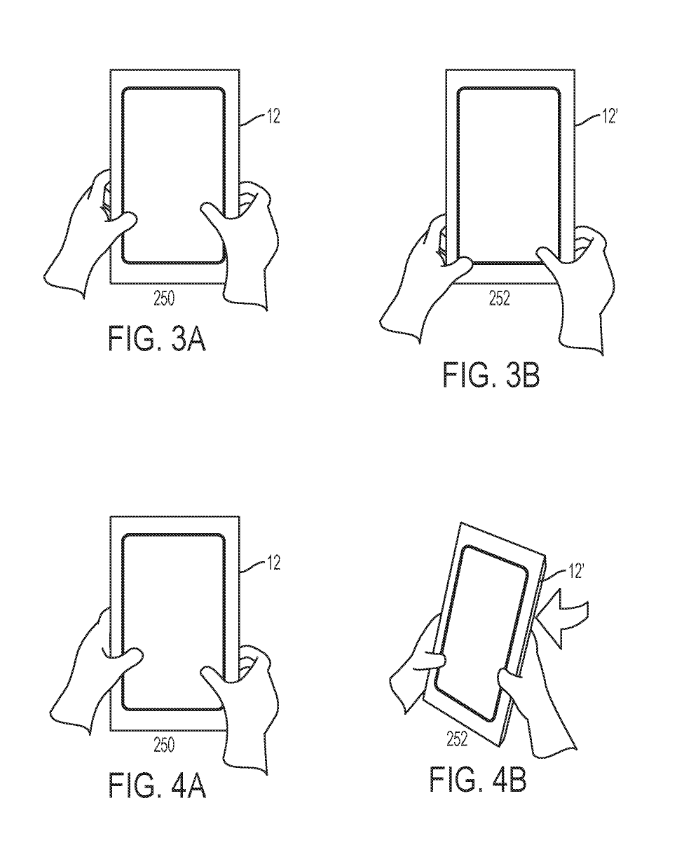

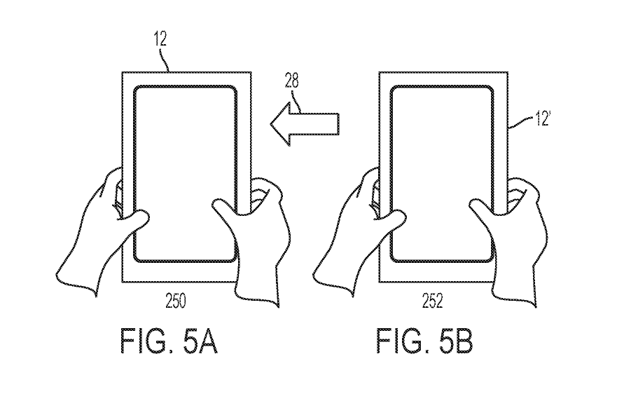

Referring now to FIGS. 3A-5B various positions of first device 12 of a first student 250 with respect to a second device 12′ of a second student 252 is illustrated. In FIGS., 3A and 3B, the first and second devices 12 and 12′ are in an appropriate location with respect to each other. However and as illustrated in FIGS. 4A and 4B the second device 12′ is in an unauthorized position with respect to its X, Y and Z axes. In these FIGS., the second device 12′ is tilted towards the first device 12 such that a first student 250 may view the second device 12′ of a second student 252. Referring now to FIGS. 5A and 5B the second device 12′ is being slid in the direction of arrow 28 towards the first student 250 such that a first student 250 may view the second device 12′ of a second student 252. FIGS. 3A-5B are simply examples of various positions of first device 12 with respect to a second device 12′ and numerous other configurations of the a first device with respect to a second device or devices are considered to be within the scope of various embodiments of present disclosure.

As disclosed herein a system, method and apparatus for detecting abnormal movements on a device 12 in order to trigger notifications to the proctors conducting the exam includes a plurality of devices or digital devices that have data transmission capabilities (e.g., Wifi) with a remote server 14 such that the digital devices 12 (e.g., portable devices, laptops) are able to receive notifications from a proctor via a proctor device 16.

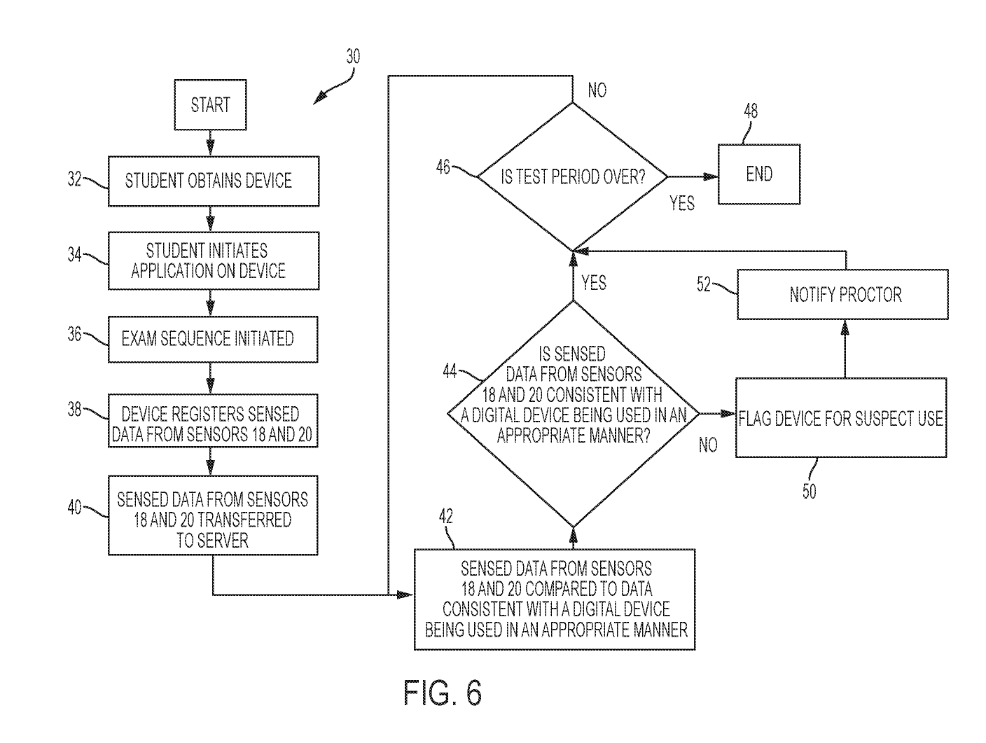

Referring now to FIG. 6 a flow chart illustrating an embodiment of a computer-implemented method 30 for detection of anomalous behavior in a digital education setting is shown. In a first step, illustrated by box 32 each student or test taker takes one of plurality of the digital devices 12. At a second step, illustrated by box 34, the student who has taken one of the digital devices 12 initiates an application on the device 12 wherein a user of the device provides user inputs to select, by a processor of the device one or more applications resident upon the digital device 12. As used herein, application on the digital device 12 may refer to a computer program capable of performing a series of steps on the device 12, which for example, may include retrieval of an exam from the remote server 14. In addition to the retrieval of the exam, the application will also register the student's enrollment in the exam providing along with this information the user's name and if applicable, their student ID. Still further and in one embodiment, the registration step may also include location of the digital device 12 with respect to other registered digital devices 12.

Once the exam has been loaded onto the device 12, the student will begin taking the exam, which may occur simultaneously along all of the devices 12 or each student may individually begin or initialize the exam taking process. The beginning of the exam taking process is illustrated by box 36. After this step has been performed, the initialized application of the digital device 12 will periodically (e.g., 100 measurements per second or any other suitable measurement period greater or less than 100 measurements per second) register sensed data or sensor data from the sensors (e.g., gyroscope 18 and an accelerometer sensor or sensors 20) of the digital device 12. This is represented at box 38. Non-limiting examples of sensed data are: acceleration, orientation, pitch, yaw, etc., which may be attributable to the device 12 being held in an inappropriate manner consistent with cheating or other anomalous behavior.

This sensed data is then periodically (e.g., every second or any other suitable period greater or less than one second) is submitted or uploaded to the remote server 14, which is represented by box 40.

The remote sever 14 upon receipt of this data, uses it in a software application that is configured to identify potential anomalous behavior based on the sensor data. This step is illustrated at box 42. For example, the software application will upon receipt of the sensed data compare that to data consistent with a digital device being used in an appropriate manner. This is illustrated by decision node 44. If the sensed data is consistent with a digital device being used in an appropriate manner the program continues to compare updated or newly sensed data with that of data consistent with a digital device being used in an appropriate manner until the test period has ended. This is illustrated by decision nodes 46 and/or boxes 48 and 42.

If on the other hand, the sensed data is determined to be not consistent with a digital device being used in an appropriate manner at decision node 44, the program will flag the device 12 for inappropriate use as illustrated by box 50 and the proctor will be notified, which is illustrated by box 52.

It is, of course, understood that the flow chart of FIG. 30 may be employed for a plurality of devices 12 being used in a test taking environment wherein each of the devices 12 individually provides its sensed positional data to the server 14 and the server 14 individually compares the sensed data of each of these devices to data consistent with a digital device being used in an appropriate manner.

Accordingly, the system will be able to determine whether the equipped digital device 12 is in a position which is significantly different from one observed for a student who's device 12 is not in a potential cheating position or inappropriate position (e.g., 90 degrees higher than usual).

Other conditions that may be detected by the server 14 include abnormal shaking behavior of the device 12, which may be detected for example, if a student usually holds the tablet or device as a book but the device starts to shake, as this may be indicate of a student who is nervous as they may have just done something inappropriate during the test. Another condition that may be detected is abnormal and abrupt movement of the device 12. For example, if a student moves the device 12 quickly from one side to the other. So that a fellow student may look at their answer. This is illustrated in FIGS. 5A and 5B.

In addition, the server 14 may also be able to determine if one of the plurality of devices has movements that are consistently out of synch with the detected movements of all of the other devices.

The server 14 or remote server 14 may be configured to send real-time notifications to a proctor's device 16 if potential anomalous behavior is observed. The potential anomalous behavior may also be presented to the proctors after the exam session has concluded.

The computer-implemented method may be used to in any test taking environment, including educational settings (e.g., universities, high schools, elementary schools); and administrative testing environments (e.g., licensing exams).

In an embodiment, the computer-implemented method utilizes one or more modules to perform one or more of the steps described above. Non-limiting examples of such modules include, but are not limited to, a recording module, e.g., an analytics module, and a comparison module, e.g., a decision management module.

A computer-implemented method for determining anomalous behavior in a digital education setting, the method comprising: receiving, by a processor of a computer system, data corresponding to a position of a device with respect to at least one axis of the device; determining, by the processor of the computer system, whether the position of the device is an appropriate location for an intended use of the device; and notifying, by the processor of the computer system, wherein the device is not in an appropriate location for an intended use of the device.

In another embodiment, a system for determining anomalous behavior in a digital education setting, the system comprising: a memory; a processor communicatively coupled to the memory, wherein the processor is configured to perform: receiving, by a processor of a computer system, data corresponding to a position of a device with respect to at least one axis of the device; determining, by the processor of the computer system, whether the position of the device is an appropriate location for an intended use of the device; and notifying, by the processor of the computer system, wherein the device is not in an appropriate location for an intended use of the device.

In yet another embodiment, a computer program product for determining anomalous behavior in a digital education setting, the computer program product comprising: a non-transitory storage medium readable by a processing circuit and storing instructions for execution by the processing circuit for performing a method comprising: receiving, by a processor of a computer system, data corresponding to a position of a device with respect to at least one axis of the device; determining, by the processor of the computer system, whether the position of the device is an appropriate location for an intended use of the device; and notifying, by the processor of the computer system, wherein the device is not in an appropriate location for an intended use of the device.

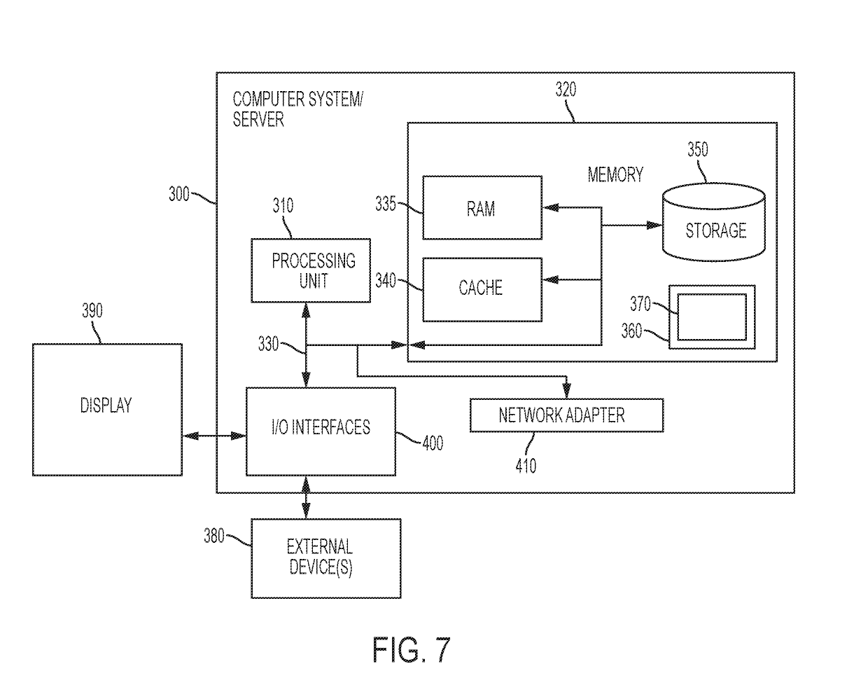

Referring to FIG. 7, a block diagram illustrating an information processing system is shown. The information processing system 300 is based upon a suitably configured processing system configured to implement one or more embodiments described herein, including the analytics module and the decision management module. Any suitably configured processing system can be used as the information processing system 300 in the embodiments described herein. The components of the information processing system 300 can include, but are not limited to, one or more processors or processing units 310, a system memory 320 and a bus 330 that couples various system components including the system memory 320 to the processor 310.

The bus 330 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture bus, Micro Channel Architecture bus, Enhanced ISA bus, Video Electronics Standards Association local bus and Peripheral Component Interconnects bus.

Although not shown in FIG. 3, the system memory 320 may include the calculating, information confidence rating and annotating information software module(s). The system memory 320 can also include computer system readable media in the form of volatile memory, such as random access memory (“RAM”) 335 and/or cache memory 340. The information processing system 300 can further include other removable/non-removable, volatile/non-volatile computer system storage media. By way of example only, a storage system 350 can be provided for reading from and writing to a non-removable or removable, non-volatile media such as one or more solid state disks and/or magnetic media (typically called a “hard drive”). A magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus 330 by one or more data media interfaces. The memory 320 can include at least one program product having a set of program modules that are configured to carry out the functions of the embodiment described herein.

Program/utility 360, having a set of program modules 370, may be stored in memory 320 by way of example, and not limitation, as well as an operating system, one or more application programs, other program modules, and program data. Each of the operating system, one or more application programs, other program modules, and program data or some combination thereof, may include an implementation of a networking environment. Program modules 370 generally carry out the functions and/or methodologies of the embodiments described herein.

The information processing system 300 can also communicate with one or more external devices 380 such as a keyboard, a pointing device, a display 390, etc.; one or more devices that enable a user to interact with the information processing system 300; and/or any devices, e.g., network card, modem, etc., that enable computer system/server 300 to communicate with one or more other computing devices. Such communication can occur via I/O interfaces 400. Still yet, the information processing system 300 can communicate with one or more networks such as a local area network, a general wide area network, and/or a public network, e.g., the Internet, via network adapter 410. As depicted, the network adapter 410 communicates with the other components of information processing system 300 via the bus 330. Other hardware and/or software components can also be used in conjunction with the information processing system 300. Examples include, but are not limited to: microcode, device drivers, redundant processing units, external disk drive arrays, RAID systems, tape drives and data archival storage systems.

Certain aspects of the embodiments described herein may be a system, method or computer program product. Accordingly, the embodiments described herein may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments described herein may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory, a read-only memory, an erasable programmable read-only memory, an optical fiber, a portable compact disc read-only memory, an optical storage device, a magnetic storage device, or any suitable combination of the foregoing. In the context of this document, a computer readable storage medium may be any tangible medium that can contain, or store a program for use by or in connection with an instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for the embodiments described herein may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention have been discussed above with reference to flowchart illustrations and/or block diagrams of methods, apparatus (systems) and computer program products according to various embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality and operation of possible implementations of systems, methods and computer program products according to various embodiments of the present invention. In this regard, each block in the flowchart or block diagrams may represent a module, segment or portion of instructions which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for determining anomalous behavior in a digital education setting, the method comprising:
receiving, by a processor of a computer system, data corresponding to a position of a device with respect to at least one axis of the device;
determining, by the processor of the computer system, whether the position of the device is an appropriate location for an intended use of the device; and
notifying, by the processor of the computer system, wherein the device is not in an appropriate location for an intended use of the device.

2. The computer-implemented method of claim 1, wherein the data corresponding to the position of the device is a pitch of the device.

3. The computer-implemented method of claim 1, wherein the data corresponding to the position of the device is a yaw of the device.

4. The computer-implemented method of claim 3, wherein the data corresponding to the position of the device is a pitch of the device.

5. The computer-implemented method of claim 1, further comprising:
receiving, by the processor of the computer system, data corresponding to a position of at least one other device with respect to at least one axis of the at least one other device;
determining, by the processor of the computer system, whether the position of the at least one other device is an appropriate location for an intended use of the at least one other device; and
notifying, by the processor of the computer system, wherein the at least one other device is not in an appropriate location for an intended use of the at least one other device.

6. The computer-implemented method of claim 5, wherein the data corresponding to the position of the at least one other device is a yaw of the at least one other device.

7. The computer-implemented method of claim 6, wherein the data corresponding to the position of the at least one other device is a pitch of the at least one other device.

8. The computer-implemented method of claim 1, wherein the intended use is an exam being administered on the device.

9. The computer-implemented method of claim 1, wherein the device is a tablet or a portable digital device.

10. A system for determining anomalous behavior in a digital education setting, the system comprising:
a memory;
a processor communicatively coupled to the memory, wherein the processor is configured to perform:
receiving, by a processor of a computer system, data corresponding to a position of a device with respect to at least one axis of the device;
determining, by the processor of the computer system, whether the position of the device is an appropriate location for an intended use of the device; and
notifying, by the processor of the computer system, wherein the device is not in an appropriate location for an intended use of the device.

11. The system of claim 10, wherein the data corresponding to the position of the device is a pitch of the device.

12. The system of claim 10, wherein the data corresponding to the position of the device is a yaw of the device.

13. The system of claim 12, wherein the data corresponding to the position of the device is a pitch of the device.

14. The system of claim 10, further comprising:
receiving, by the processor of the computer system, data corresponding to a position of at least one other device with respect to at least one axis of the at least one other device;
determining, by the processor of the computer system, whether the position of the at least one other device is an appropriate location for an intended use of the at least one other device; and
notifying, by the processor of the computer system, wherein the at least one other device is not in an appropriate location for an intended use of the at least one other device.

15. The system of claim 14, wherein the data corresponding to the position of the at least one other device is a yaw of the at least one other device.

16. The system of claim 15, wherein the data corresponding to the position of the at least one other device is a pitch of the at least one other device.

17. The system of claim 10, wherein the intended use is an exam being administered on the device.

18. The system of claim 10, wherein the device is a tablet or a portable digital device.

19. A computer program product for determining anomalous behavior in a digital education setting, the computer program product comprising:
a non-transitory storage medium readable by a processing circuit and storing instructions for execution by the processing circuit for performing a method comprising:
receiving, by a processor of a computer system, data corresponding to a position of a device with respect to at least one axis of the device;
determining, by the processor of the computer system, whether the position of the device is an appropriate location for an intended use of the device; and
notifying, by the processor of the computer system, wherein the device is not in an appropriate location for an intended use of the device.

20. The computer program product of claim 19, wherein the method further comprises:
receiving, by the processor of the computer system, data corresponding to a position of at least one other device with respect to at least one axis of the at least one other device;
determining, by the processor of the computer system, whether the position of the at least one other device is an appropriate location for an intended use of the at least one other device; and
notifying, by the processor of the computer system, wherein the at least one other device is not in an appropriate location for an intended use of the at least one other device.
